(19) United States
(12) Patent Application Publication
(10) Pub. No.: US 2010/0126326 A1
(43) Pub. Date: May 27, 2010

(54) SAW BLADE AND METHOD OF MANUFACTURING THE SAME

(76) Inventor: Michael F. Cloutier, Mission (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 12/276,131

(22) Filed: Nov. 21, 2008

(51) Int. Cl. B27B 33/02; B23D 63/00

(52) U.S. Cl. 83/835; 83/852; 76/112

(57) ABSTRACT

A circular saw blade includes a substantially circular body having a plurality of protruding tip support regions spaced around the periphery thereof, each tip support region including at least a seat for supporting a cutting tip. The tip support region may further include a substantially planar upper tooth face, a grindable tip reinforcement portion and/or a lower tip angle less than 90 degrees. A cutting tip is secured to the seat of each tip support region preferably with a top face of each cutting tip substantially parallel to and offset from an upper tooth face of each tip support region. Each cutting tip of the circular saw blade is further configured to maintain a cutting edge at a substantially constant width when material is removed from the top face thereof. A method of manufacturing a saw blade is also provided.

### BACKGROUND

1. Technical Field

This disclosure is generally related to saw blades and methods of manufacturing the same, and more particularly to circular saw blades having hardened cutting tips and methods of manufacturing the same.

2. Description of the Related Art

Circular saw blades having hardened cutting tips, such as carbide tips, have been in use for many years and provide significant advantages over hardened steel blades. For example, the use of hardened cutting tips enable saw blades to operate at relatively higher cutting speeds while retaining the sharpness of a cutting edge for a relatively longer period of time. The use of saw blades with conventional hardened cutting tips, however, require periodic maintenance and/or replacement of the cutting tips that can lead to reduced productivity.

Circular saw blades having hardened tips are used, for example, in the lumber industry in sawmills for the production of dimensional lumber—the saw blades being used continuously under strenuous operating conditions. Under such conditions, the cutting tips of a saw blade are frequently worn and/or damaged, thus requiring periodic re-sharpening and/or replacement. The need to re-sharpen or replace cutting tips necessitates shutting down a saw for a period of time and leads to diminished productivity. The frequency of tip replacement or re-sharpening thereby has an effect on the overall efficiency of lumber production.

Accordingly, saw blades utilizing cutting tips with enhanced wear and performance properties over conventional saw blades are desired, particularly for use in the lumber industry. The saw blades should feature improved durability and increased consistency in cutting performance and should minimize downtime required for blade maintenance.

### BRIEF SUMMARY

At least one embodiment may be summarized as a saw blade including a plurality of protruding tip support regions spaced around the periphery of a substantially circular body, each tip support region having a substantially planar upper tooth face and a tip seat, and a plurality of cutting tips wherein each cutting tip is secured to the tip seat of each tip support region with a top face of each cutting tip substantially parallel to and offset from each respective upper tooth face. The tip support region may further include a grindable tip reinforcement portion configured to support each respective cutting tip on at least a portion of a back face thereof. The tip seat of each tip support region may further include a shoulder having a receiving angle less than 90 degrees to receive a portion of the cutting tip secured therein, and preferably a receiving angle of about 70 degrees. The top face of each cutting tip may be offset from each respective upper tooth face by at least 0.030 inches. Each cutting tip may be configured to maintain a cutting edge at a substantially constant width when material is removed from the top face of each cutting tip. Each cutting tip may be configured to maintain a cutting edge within 0.003 inches of an initial cutting width when material is removed from the top face of the cutting tip from an initial top clearance to a condition when the upper tooth face proximate the cutting tip is substantially coplanar with the top face. Each of the cutting tips may be configured to have an initial tangential angle of about 2 degrees and an initial radial angle of about 1.5 degrees. For each cutting tip, a ratio of a length of the cutting tip to the initial distance between the top face of the cutting tip and the upper tooth face of the tip support region proximate thereto may be less than 17:1, and preferably less than 12:1. For each cutting tip, a ratio of a thickness of the cutting tip to the initial distance between the top face of the cutting tip and the upper tooth face of the tip support region proximate thereto may be less than 4:1, and preferably less than 3:1. A front face of each cutting tip may be coated with a hardening agent. The hardening agent may be titanium aluminum nitride.

At least one embodiment may be summarized as a saw blade including a plurality of protruding tip support regions spaced around the periphery of a substantially circular body, each tip support region having a grindable tip reinforcement portion and a tip seat, and a plurality of cutting tips, each cutting tip secured to the tip seat of each tip support region, and wherein the grindable tip reinforcement portion of each tip support region is configured to support each respective cutting tip on at least a portion of a back face thereof. The tip seat of each tip support region may include a shoulder having a receiving angle less than 90 degrees to receive a portion of the cutting tip secured therein. Each tip support region may further include a substantially planar upper tooth face wherein a top face of each cutting tip is substantially parallel to and offset from each respective upper tooth face. The top face of each cutting tip may be offset from each respective upper tooth face by at least 0.030 inches. Each cutting tip may be configured to maintain a cutting edge at a substantially constant width when material is removed from the top face of each cutting tip. At least one embodiment may be summarized as a cutting tip having a unitary tip body, the tip body including: a front face having a hardening agent applied thereto; a top face contiguous with the front face at a cutting edge, the cutting edge having an initial cutting width; and a first side face and a second side face located on opposite sides of the tip body and contiguous with both the front face and the top face, each of the first side face and the second side face characterized by a radial angle and a tangential angle, the radial angle and tangential angle configured to maintain the initial cutting width substantially constant throughout a usable depth of the cutting tip. The cutting tip may have a usable depth of at least 0.030 inches. The cutting tip may have an initial tangential angle of about 2 degrees and an initial radial angle of about 1.5 degrees. The difference between the initial cutting width and a width across the front face throughout the usable depth may be less than or equal to 0.003 inches. A ratio of a length of the cutting tip to the usable depth of the cutting tip may be less than 17:1, and preferably less than 12:1. A ratio of a thickness of the cutting tip to the usable depth of the cutting tip may be less than 4:1, and preferably less than 3:1. The unitary tip body of the cutting tip may further include a back face contiguous with the top face and both the first side face and the second side face, and a bottom face located opposite the front face, wherein a lower tip angle between the back face and the bottom face of the tip body is less than 90 degrees, and preferably about 70 degrees.

At least one embodiment may be summarized as a method for manufacturing a saw blade including: securing a plurality of cutting tips to a body of the saw blade, each cutting tip positioned in a tip seat of a tip support region of the body, the tip support region including an upper tooth face oriented at a back angle; grinding a top face of each of the cutting tips to a top angle substantially equal to the back angle such that the top face is substantially parallel to and offset from each respective upper tooth face by a usable depth; and grinding a first side face and a second side face of each of the cutting tips to an initial radial angle and an initial tangential angle, the radial angle and tangential angle configured to maintain a cutting width of each of the cutting tips substantially constant throughout the usable depth. Grinding a top face of each of the cutting tips may include grinding a top face of each of the cutting tips such that each top face is offset from each respective upper tooth face by a usable depth of at least 0.030 inches. Grinding a first side face and a second side face of each of the cutting tips to an initial radial angle and an initial tangential angle may include grinding a first side face and a second side face of each of the cutting tips to an initial radial angle and an initial tangential angle such that the cutting width of each cutting tip is maintained within 0.003 inches throughout the usable depth of the cutting tip. Grinding a first side face and a second side face of each of the cutting tips to an initial radial angle and an initial tangential angle may include grinding a first side face and a second side face of each of the cutting tips to an initial tangential angle of about 2 degrees and an initial radial angle of about 1.5 degrees. The method may further include applying a hardening agent to at least a front face of each of the cutting tips. The hardening agent may be titanium aluminum nitride.

### BRIEF DESCRIPTION OF THE SEVERAL VIEWS OF THE DRAWINGS

FIG. 1 is a perspective view of a saw blade according to one embodiment.

FIG. 2 is an enlarged detail side view of a portion of the saw blade of FIG. 1.

FIG. 3 is a sectional view of the portion of the saw blade of FIG. 2 taken along line 3-3.

FIG. 4 is a sectional view of the portion of the saw blade of FIG. 2 taken along line 4-4.

FIG. 5 is a perspective view of the portion of the saw blade of FIG. 2.

FIG. 6 is a side elevational view of a tip of a saw blade according to one embodiment.

### DETAILED DESCRIPTION

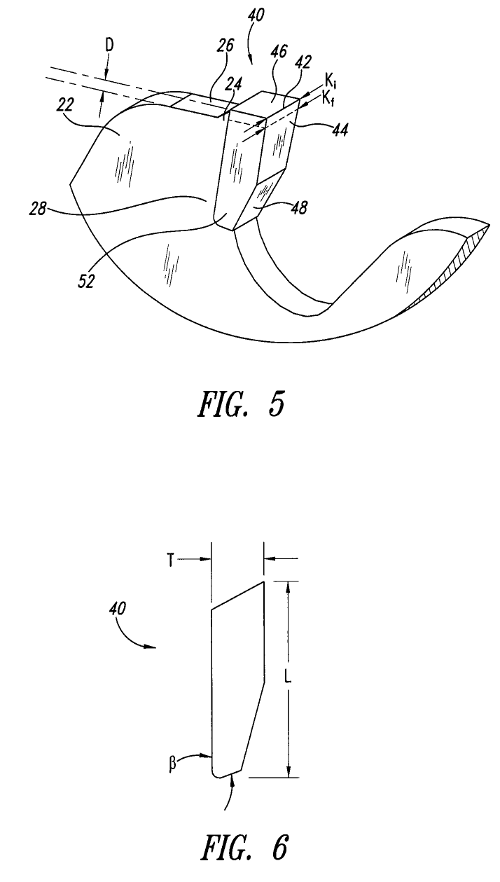

FIGS. 1 through 5 illustrate one embodiment of a circular saw blade 10 having enhanced wear and performance characteristics particularly suitable for use in the lumber industry. As shown in FIG. 1, the saw blade 10 includes a plurality of teeth 20 spaced about the periphery of a substantially circular body 12. The blade 10 further includes a central aperture 16 for mounting the blade 10 on the arbor of a conventional circular saw. The teeth 20 of the saw blade 10 are spaced about the periphery of the blade body 12 with gullets located therebetween to assist in chip removal. In operation, the blade 10 rotates about a center of rotation R in the direction indicated in FIG. 1.

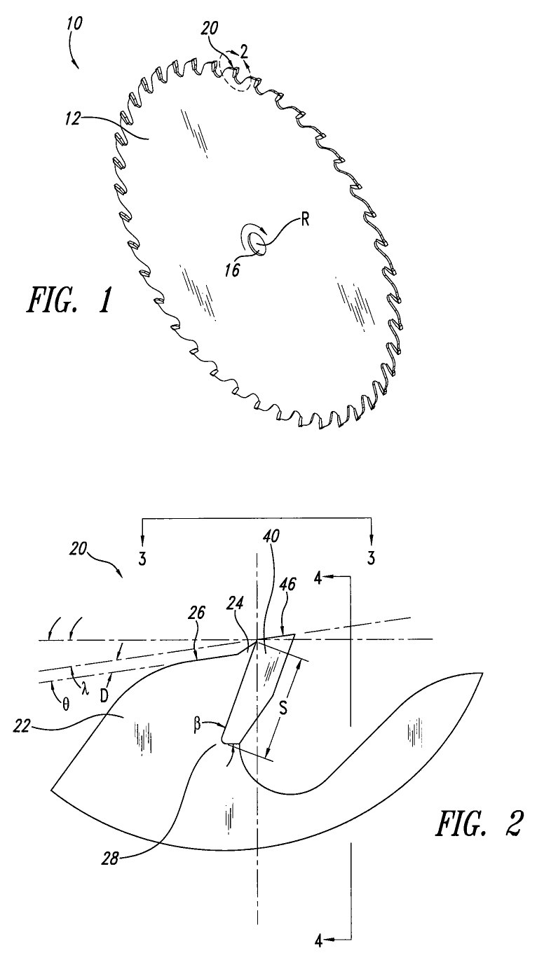

With reference to FIG. 2, each tooth 20 includes a cutting tip 40 secured to a tip support region 22. The tip support region 22 includes a tip seat 28 for receiving the cutting tip 40 and providing structural support thereto. The cutting tips 40 are preferably made of a hardened material, for example, carbide or other cobalt-based alloys. The cobalt-based superalloy APF 12υ available from Camco Cutting Tools Ltd. of Kelowna, British Columbia, Canada, is particularly suited for use as a cutting tip 40. The cutting tips 40 may be secured to the tip seat 28 via brazing or welding, although other attachment methods may be used. In some embodiments, the tip seat 28 includes a shoulder having a receiving angle less than 90 degrees and preferably about 70 degrees to substantially match a corresponding lower tip angle β of the cutting tip 40. The tip seat 28 with a shoulder having a receiving angle less than 90 degrees assists in securely receiving the cutting tip 40 and resists dislodgement of the cutting tip 40 during operation. A tip seat 28 with a shoulder having a receiving angle at about 70 degrees is particularly suited for resisting dislodgement of the cutting tip 40.

In some embodiments, the tip support region 22 may further include an upper tooth face 26 having a back angle θ with respect to a plane tangent to the saw blade 10 at a location on the cutting tip 40. The back angle θ is preferably set substantially equal to a top angle λ of the cutting tip 40. In this manner, a top face 46 of the cutting tip 40 is substantially parallel to and offset from the upper tooth face 26 of the tip support region 22 by a top clearance or usable depth D. In some embodiments, the top clearance or usable depth D is set to be equal to or greater than 0.030 inches, preferably greater than 0.035 inches, and more preferably at about 0.050 inches. Tip fracture becomes increasingly prevalent as the usable depth D is extended beyond 0.050 inches.

Because the upper tooth face 26 and the top face 46 of the cutting tip 40 are substantially parallel, the cutting tip 40 may be ground during re-sharpening or during operation to a condition where the upper tooth face 26 proximate the cutting tip 40 is substantially coplanar with the top face 46 thereof. In other words, a user of the saw can run the saw until the usable depth D reaches zero. This enables the saw blade 10 to be used for a relatively longer period of time by maximizing an effective usable depth D of the cutting tip 40.

In some embodiments, the tip support region 22 may further include a grindable tip reinforcement portion 24 for supporting a portion of the cutting tip 40 that extends beyond the upper tooth face 26. The tip reinforcement portion 24 effectively increases a seat depth S to more securely receive the cutting tip 40. The seat depth S may extend the entire length of a back face of the cutting tip 40 or some portion thereof. In this manner, the grindable tip reinforcement portion 24 helps to prevent tip fracture, particularly in saw blades with a relatively large usable depth D. During re-sharpening the grindable tip reinforcement portion 24 may be ground simultaneously with a top surface 46 of the cutting tip 40. Preferably, the tip reinforcement portion 24 comprises a relatively small volume compared to the volume of the cutting tip portion to be removed such that removal of the tip reinforcement portion 24 does not significantly interfere with the re-sharpening process.

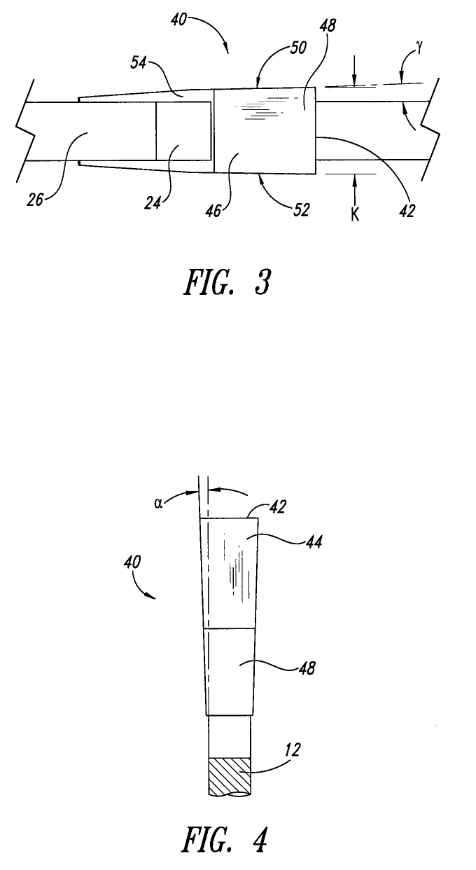

With reference to FIGS. 3 through 5, each cutting tip 40 includes a tip body 48 having a cutting edge 42 formed by the intersection of a front face 44 of the tip body 48 with a top face 46 of the same, the cutting edge 42 having a cutting width or kerf K. Each cutting tip 40 further includes a first side face 50 and a second side face 52 located on opposite sides of the tip body 48. Each of the first side face 50 and second side face 52 are formed by grinding or removing a portion of the cutting tip 40 at a tangential angle γ as illustrated in FIG. 3 and a radial angle α as illustrated in FIG. 4 such that the resulting side faces 50, 52 gradually slope away from the cutting edge 42 at a composite angle. In this manner, clearance is provided in a tangential direction and a radial direction to aid in smooth operation of the saw blade 10.

In a preferred embodiment, the dimensions of the cutting tips 40, including the tangential angle γ and the radial angle α (collectively referred to as clearance angles), are set such that the cutting width K of the cutting edge 42 is maintained substantially constant as the cutting tip 40 is worn or ground down through a usable depth D (i.e., as the top clearance is reduced). For example, in one embodiment, the cutting tip 40 includes an initial tangential angle γ of about 2 degrees and an initial radial angle α of about 1.5 degrees and is secured to the tip support region 22 with a top clearance or usable depth D of 0.050 inches such that the cutting edge 42 is maintained within 0.003 inches of an initial cutting width Ki throughout the usable depth D. In other words, the difference between the initial cutting width Ki and a final cutting width Kf offset from the initial cutting width Ki by the usable depth D is less than or equal to 0.003 inches. Although it is preferred that the initial tangential angle γ is about 2 to 3 degrees, and more preferably about 2 degrees, and that the initial radial angle α is about 1 to 3 degrees, and more preferably about 1.5 degrees, in some embodiments the initial tangential angle γ and the initial radial angle α may exceed such values, and in other embodiments, may be less than such values.

Maintaining a consistent cutting width K is enabled in part by maintaining relatively low clearance angles γ, α and, in accordance with some embodiments, providing a cutting tip 40 which requires sharpening via grinding only on a top face 46 thereof, as discussed in more detail below. Maintaining a consistent cutting width K is advantageous in that it allows for tighter tolerances in, for example, the production of lumber and enables a saw mill to drop the target size of processed wood, thus resulting in higher recovery.

In some embodiments, at least the front face 44 of the cutting tip 40 is coated with a hardening agent by, for example, a physical vapor deposition or PVD coating process. Cutting tips 40 may be coated prior to attachment to the saw blade 10, or alternatively, may be coated thereafter. Preferably, one or more faces of the cutting tips 40 are coated with titanium aluminum nitride (TiAlN), although other PVD coatings may be used. The one or more faces of the cutting tips 40, including the front face 44 and/or side faces 50, 52, are preferably coated with approximately 3 to 5 microns of the hardening agent. The addition of the hardening agent increases the hardness of the cutting tip 40 and the ability of the cutting tip 40 to maintain a sharp cutting edge 42 for a relatively longer period of time, thus allowing for longer runtimes between re-sharpening of the cutting tips 40. When a cutting tip 40 eventually dulls, the addition of the hardening agent reduces or eliminates the need to grind both the front face 44 and top face 46 of the cutting tip 40 to reform a sharpened cutting edge 42. Consequently, the tip 40 can be sharpened by grinding only the top face 46 which prevents the cutting width or kerf K from being unnecessarily reduced through reduction that would otherwise occur when grinding the front face 44. In this manner, the kerf K is maintained substantially constant despite the cutting tip 40 being repeatedly sharpened—a feature that allows for tighter controlled tolerances during operation of the saw blade. For example, in the context of the lumber industry, an initial kerf Ki may be set about 0.010 inches less than a kerf of conventional saw blades due to the ability to maintain a substantially constant cutting width K throughout the life of the cutting tips 40 and saw blade 10. Again, this allows a mill to drop the target size of all processed wood, thus resulting in higher recovery.

With reference to FIG. 6, a cutting tip 40 is characterized in part by a thickness T and an initial length L. The initial length L and thickness T of the cutting tip 40 are selected to be relatively large compared to standard cutting tips. For example, the length L of the cutting tip 40 is at least 0.025 inches longer than standard cutting tips which range between 5/16 (0.312) of an inch and 9/16 (0.535) of an inch, and is preferably at least 0.050 inches longer. A cutting tip 40 having a relatively large initial length L and thickness T is particularly suited to provide a cutting tip 40 having an increased usable depth D such that the life of the cutting tip 40 is increased to a point wherein it becomes economically feasible to replace the saw blade 10 when the tips 40 are completely worn, as opposed to re-tipping a saw blade one or more times throughout the life of the blade. The usable depth D of the cutting tip 40 is equal to or greater than 0.030 inches, preferably greater than 0.035 inches, and more preferably about 0.050 inches. When the usable depth D of the cutting tip 40 is about 0.050 inches, the cutting tip 40 may be incrementally sharpened, for example, in 0.002 to 0.003 inch increments, thereby allowing the blade 10 to be sharpened approximately twenty times over the life of the tip 40. The usable depth D is preferably set to a sufficient depth such that the life of the cutting tip 40 coincides or exceeds the life of the blade body 12, wherein the life of the blade body 12 is dependent on numerous factors, including, for example, the width of the blade body 12 and the material being cut by the saw blade 10. Generally, at the end of the life-cycle, the blade body 12 reaches a condition where straight cuts cannot be maintained within acceptable tolerances due to fatigue of the blade body 12. At this point, the saw blade 10 is discarded or recycled.

In some embodiments, the cutting tip 40 further includes a lower tip angle β less than 90 degrees for nesting each cutting tip 40 in a shoulder of each tip seat 28—the lower tip angle β defining an angle between the back face 54 of the cutting tip 40 and a bottom face 56 of the same. In other embodiments, the lower tip angle β is less than 80 degrees and preferably about 70 degrees. In such embodiments, the lower tip angle β is particularly adapted to assist in ensuring that the cutting tip 40 is securely received in the tip seat 28 and to resist dislodgement of the cutting tip 40 during operation.

In some embodiments, a ratio of the initial length L of the cutting tip 40 to the usable depth D is less than 17:1, preferably less than 14:1, and more preferably less than 12:1. In some embodiments a ratio of the thickness T of the cutting tip 40 to the usable depth D is less than 4:1, preferably less than 3.5:1, and more preferably less than 3:1. Cutting tips 40 having the disclosed length L to usable depth D ratio and thickness T to usable depth D ratio are particularly suited for increasing the life and durability of the cutting tips 40.

In one embodiment, the initial length L of the cutting tip 40 is about 0.593 inches, the thickness T is about 0.150 inches and the usable depth D is about 0.050 inches such that the ratio of initial length to usable depth L:D is approximately 11.9 to 1 and the ratio of the thickness to usable depth T:D is approximately 2.9 to 1.

A width of the cutting tip 40 varies in accordance with a thickness of the saw blade body 12 and desired cutting width or kerf K—the width of the tip 40 exceeding the thickness of said blade body 12. In one embodiment, for example, a cutting tip 40 having a width of 0.145 inches is utilized on a saw body having a width of about 0.100 inches and ground such that an initial cutting width Ki is formed equal to about 0.140 inches and maintained substantially constant over the usable depth D of the cutting tip 40.

A method for manufacturing a saw blade 10 according to one embodiment begins where a blade body 12 having a central aperture 16 is cut using a laser or water-jet machine such that the body 12 includes a plurality of tip support regions 22 having an upper tooth face 26 with a predetermined back angle θ, a tip seat 28 and optionally a grindable tip reinforcement portion 24. The tip seat 28 may further include a shoulder having a receiving angle less than 90 degrees and preferably about 70 degrees to substantially match a corresponding lower tip angle β of the cutting tip 40 to be placed therein. After cutting the blade body 12, the body 12 is ground to a required thickness and the tip seat 28 of each tip support region 22 is ground or milled to ensure proper fit with and placement of cutting tips 40 therein—the tip seat 28 having an increased length and depth to securely receive the cutting tips 40. After grinding each tip seat 28, the blade body 12 is then tensioned and flattened. Subsequently, a cutting tip 40 is secured to each tip seat 28 by brazing or welding at least a portion of a back face 54 of the cutting tip 40 to the tip seat 28 with a manual torch or auto-tipper machine.

Next, each of the cutting tips 40 are subjected to grinding on at least a top face 46, a first side face 50 and a second side face 52 thereof. The top face 46 is ground to a top angle λ that is substantially equal to the back angle θ of the upper tooth face 26 so that the top face 46 is substantially parallel to and offset from the upper tooth face 26 by a usable depth D. In grinding the top face 46, a sharpened cutting edge 42 is formed at the intersection of the top face 46 and a front face 44 of the cutting tip 40. Each of the first side face 50 and the second side face 52 are ground to an initial radial angle α and an initial tangential angle γ—the radial angle α and tangential angle γ being set to maintain a cutting width or kerf K of the cutting edge 42 substantially constant throughout the usable depth D of the cutting tip 40.

In some embodiments, some of the acts may be performed in different orders. For example, the tensioning and flattening of the saw blade body 12 may be performed before grinding the tip seat 28 of each of the tip support regions 22. In addition, in some embodiments, the cutting tips 40 may be ground or shaped prior to being secured to the blade body 12. In this manner, cutting tips 40 having a predefined tangential angle γ and radial angle α may be supplied apart from the saw blade body 12. Furthermore, in other embodiments, the top angle λ of each cutting tip 40 may vary from the back angle θ of the tip support regions 22, or the tip support regions 22 may be cut to include non-planar upper surfaces such that the top face 46 of each cutting tip 40 is not substantially parallel to an upper tooth face 26.

Although cutting tips 40 may be replaced, it is appreciated that in accordance with aspects of the described embodiments, a saw blade 10 may be discarded or recycled when the cutting tips 40 become completely worn, i.e., when the top face 46 of each tooth 20 is ground down until the top face 46 is substantially coplanar with the upper tooth face 26 of the tip support region 22 proximate thereto. Disposal of the saw blade is made economically feasible by increasing the life and performance capabilities of the cutting tips 40 to the point where the life of the cutting tips 40 corresponds to at least a substantial portion of the life of the blade body 12, and preferably meets or exceeds it. In this manner, the saw blade 10 does not require re-tipping during its lifetime and is simply discarded or recycled when the cutting tips 40 are completely warn or when the blade body 12 reaches a condition where straight cuts can not be made within acceptable tolerances due to fatigue of the blade body 12. Consequently, according to some embodiments, a disposable saw blade 10 is provided, the saw blade 10 featuring cutting tips 40 having a relatively large usable depth D, initial length L and thickness T, and the ability to maintain a substantially constant cutting width or kerf K throughout the life of the cutting tip 40.

Although some embodiments have been described with particular reference to the lumber industry for processing lumber, various embodiments may be suitable for a variety of other materials and applications, such as, for example, cutting ferrous and non-ferrous metals. In addition, aspects of the described embodiments are applicable to saw blades of all diameters and plate thicknesses.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A saw blade comprising:
a plurality of protruding tip support regions spaced around the periphery of a substantially circular body, each tip support region having a substantially planar upper tooth face and a tip seat; and
a plurality of cutting tips, each cutting tip secured to the tip seat of each tip support region with a top face of each cutting tip substantially parallel to and offset from each respective upper tooth face.

2. The saw blade of claim 1, wherein each tip support region includes a grindable tip reinforcement portion configured to support each respective cutting tip on at least a portion of a back face thereof.

3. The saw blade of claim 1, wherein each tip seat of the tip support regions includes a shoulder having a receiving angle less than 90 degrees to receive a portion of the cutting tip secured therein.

4. The saw blade of claim 3, wherein the receiving angle of the shoulder of each tip seat is about 70 degrees.

5. The saw blade of claim 1, wherein the top face of each cutting tip is offset from each respective upper tooth face by at least 0.030 inches.

6. The saw blade of claim 1, wherein each cutting tip is configured to maintain a cutting edge at a substantially constant width when material is removed from the top face thereof.

7. The saw blade of claim 1, wherein for each cutting tip, the cutting tip is configured to maintain a cutting edge within 0.003 inches of an initial cutting width when material is removed from the top face of the cutting tip from an initial top clearance to a condition when the upper tooth face proximate the cutting tip is substantially coplanar with the top face.

8. The saw blade of claim 1, wherein each of the cutting tips is configured to have an initial tangential angle of about 2 degrees and an initial radial angle of about 1.5 degrees.

9. The saw blade of claim 1, wherein for each cutting tip, a ratio of a length of the cutting tip to the initial distance between the top face of the cutting tip and the upper tooth face of the tip support region proximate thereto is less than 17:1.

10. The saw blade of claim 1, wherein for each cutting tip, a ratio of a length of the cutting tip to the initial distance between the top face of the cutting tip and the upper tooth face of the tip support region proximate thereto is less than 12:1.

11. The saw blade of claim 1, wherein for each cutting tip, a ratio of a thickness of the cutting tip to the initial distance between the top face of the cutting tip and the upper tooth face of the tip support region proximate thereto is less than 4:1.

12. The saw blade of claim 1, wherein for each cutting tip, a ratio of a thickness of the cutting tip to the initial distance between the top face of the cutting tip and the upper tooth face of the tip support region proximate thereto is less than 3:1.

13. The saw blade of claim 1, wherein a front face of each cutting tip is coated with a hardening agent.

14. The saw blade of claim 13, wherein the hardening agent is titanium aluminum nitride.

15. A saw blade comprising:
a plurality of protruding tip support regions spaced around the periphery of a substantially circular body, each tip support region having a grindable tip reinforcement portion and a tip seat; and
a plurality of cutting tips, each cutting tip secured to the tip seat of each tip support region, and wherein the grindable tip reinforcement portion of each tip support region is configured to support each respective cutting tip on at least a portion of a back face thereof.

16. The saw blade of claim 15, wherein each tip seat of the tip support regions includes a shoulder having a receiving angle less than 90 degrees to receive a portion of the cutting tip secured therein.

17. The saw blade of claim 15, wherein each tip support region includes a substantially planar upper tooth face, and wherein a top face of each cutting tip is substantially parallel to and offset from each respective upper tooth face.

18. The saw blade of claim 17, wherein the top face of each cutting tip is offset from each respective upper tooth face by at least 0.030 inches.

19. The saw blade of claim 15, wherein each cutting tip is configured to maintain a cutting edge at a substantially constant width when material is removed from the top face thereof.

20. A cutting tip having a unitary tip body, the tip body comprising:
a front face having a hardening agent applied thereto;
a top face contiguous with the front face at a cutting edge, the cutting edge having an initial cutting width; and
a first side face and a second side face located on opposite sides of the tip body and contiguous with both the front face and the top face, each of the first side face and the second side face characterized by a radial angle and a tangential angle, the radial angle and tangential angle configured to maintain the initial cutting width substantially constant throughout a usable depth of the cutting tip.

21. The cutting tip of claim 20, wherein the usable depth is at least 0.030 inches.

22. The cutting tip of claim 20, wherein the initial tangential angle is about 2 degrees and the initial radial angle is about 1.5 degrees.

23. The cutting tip of claim 20, wherein the difference between the initial cutting width and a width across the front face throughout the usable depth is less than or equal to 0.003 inches.

24. The cutting tip of claim 20, wherein a ratio of a length of the cutting tip to the usable depth of the cutting tip is less than 17:1.

25. The cutting tip of claim 20, wherein a ratio of a length of the cutting tip to the usable depth of the cutting tip is less than 12:1.

26. The cutting tip of claim 20, wherein a ratio of a thickness of the cutting tip to the usable depth of the cutting tip is less than 4:1.

27. The cutting tip of claim 20, wherein a ratio of a thickness of the cutting tip to the usable depth of the cutting tip is less than 3:1.

28. The cutting tip of claim 20, wherein the tip body further comprises:
a back face contiguous with the top face and both the first side face and the second side face; and
a bottom face located opposite the front face, wherein a lower tip angle between the back face and the bottom face of the tip body is less than 90 degrees.

29. The cutting tip of claim 28, wherein the lower tip angle between the back face and the bottom face of the tip body is about 70 degrees.

30. A method for manufacturing a saw blade comprising:
securing a plurality of cutting tips to a body of the saw blade, each cutting tip positioned in a tip seat of a tip support region of the body, the tip support region including an upper tooth face oriented at a back angle;
grinding a top face of each of the cutting tips to a top angle substantially equal to the back angle such that the top face is substantially parallel to and offset from each respective upper tooth face by a usable depth; and
grinding a first side face and a second side face of each of the cutting tips to an initial radial angle and an initial tangential angle, the radial angle and tangential angle configured to maintain a cutting width of each of the cutting tips substantially constant throughout the usable depth.

31. The method according to claim 30, wherein grinding a top face of each of the cutting tips includes grinding a top face of each of the cutting tips such that each top face is offset from each respective upper tooth face by a usable depth of at least 0.030 inches.

32. The method according to claim 30, wherein grinding a first side face and a second side face of each of the cutting tips to an initial radial angle and an initial tangential angle includes grinding a first side face and a second side face of each of the cutting tips to an initial radial angle and an initial tangential angle such that the cutting width of each cutting tip is maintained within 0.003 inches throughout the usable depth of the cutting tip.

33. The method according to claim 30, wherein grinding a first side face and a second side face of each of the cutting tips to an initial radial angle and an initial tangential angle includes grinding a first side face and a second side face of each of the cutting tips to an initial tangential angle of about 2 degrees and an initial radial angle of about 1.5 degrees.

34. The method according to claim 30, further comprising:
applying a hardening agent to at least a front face of each of the cutting tips.

35. The method according to claim 34, wherein applying a hardening agent to at least the front face of each of the cutting tips includes applying titanium aluminum nitride to at least the front face of each of the cutting tips.
